(19) United States
(12) Patent Application Publication
(10) Pub. No.: US 2024/0103585 A1
(43) Pub. Date: Mar. 28, 2024

(54) DISPLAY DEVICE AND INPUT DEVICE

(71) Applicant: LENOVO (SINGAPORE) PTE. LTD., Singapore (SG)

(72) Inventors: Jeffrey E Skinner, Morrisville, NC (US); Ali Ent, Morrisville, NC (US); Ghwang Hyun Lim, Morrisville, NC (US); Alden Rose, Morrisville, NC (US); Jung Hwan Hong, Morrisville, NC (US)

(21) Appl. No.: 17/954,843

(22) Filed: Sep. 28, 2022

(51) Int. Cl. G06F 1/16; F16C 11/04

(52) U.S. Cl. CPC G06F 1/1681; F16C 11/04; G06F 1/1616

(57) ABSTRACT

A system can include a display device that includes a display device housing, a display, a display side, a back side, a back side flap and a flap hinge that couples the back side flap to the housing; and an input device that includes an input device housing, a support flap and a support flap hinge that couples the support flap to the input device housing, where the support flap includes a coupling that couples the support flap to the back side flap of the display device.

### TECHNICAL FIELD

Subject matter disclosed herein generally relates to technology for computing devices.

### BACKGROUND

Various types of computing devices have one or more housings. For example, a tablet computing device (e.g., a tablet) can have a single housing with a display and a notebook computing device (e.g., a notebook) can have two housings where one of the housings is a display housing and the other one of the housings is a keyboard housing where the two housings are coupled by a hinge assembly.

### SUMMARY

A system can include a display device that includes a display device housing, a display, a display side, a back side, a back side flap and a flap hinge that couples the back side flap to the housing; and an input device that includes an input device housing, a support flap and a support flap hinge that couples the support flap to the input device housing, where the support flap includes a coupling that couples the support flap to the back side flap of the display device. Various other apparatuses, systems, methods, etc., are also disclosed.

### BRIEF DESCRIPTION OF THE DRAWINGS

Features and advantages of the described implementations can be more readily understood by reference to the following description taken in conjunction with examples of the accompanying drawings.

FIG. 1 is a series of diagrams of an example of a device;

FIG. 2A and FIG. 2B are a series of perspective views of an example of a system;

FIG. 3 is a plan view of an example of an input device;

FIG. 4 is a series of views of an example of a system;

FIG. 5 is a side view of an example of a system;

FIG. 6 is a side view of an example of a scenario of a user and an example of a system;

FIG. 7 is a series of side views of examples of transitions of an example of a system;

FIG. 8 is a series of side views of an example of a transition of an example of a system;

FIG. 9 is a series of side views of an example of a transition of an example of a system;

FIG. 10 is a series of views of an example of an input device and example devices;

FIG. 11 is a plan view of an example of an input device;

FIG. 12 is a plan view of an example of an input device;

FIG. 13 is a series of views of examples of arrangements of magnetic materials and connectors;

FIG. 14 is a series of views of examples of hinges; and

FIG. 15 is a diagram of an example of a system that includes one or more processors.

### DETAILED DESCRIPTION

The following description includes the best mode presently contemplated for practicing the described implementations. This description is not to be taken in a limiting sense, but rather is made merely for the purpose of describing general principles of various implementations. The scope of invention should be ascertained with reference to issued claims.

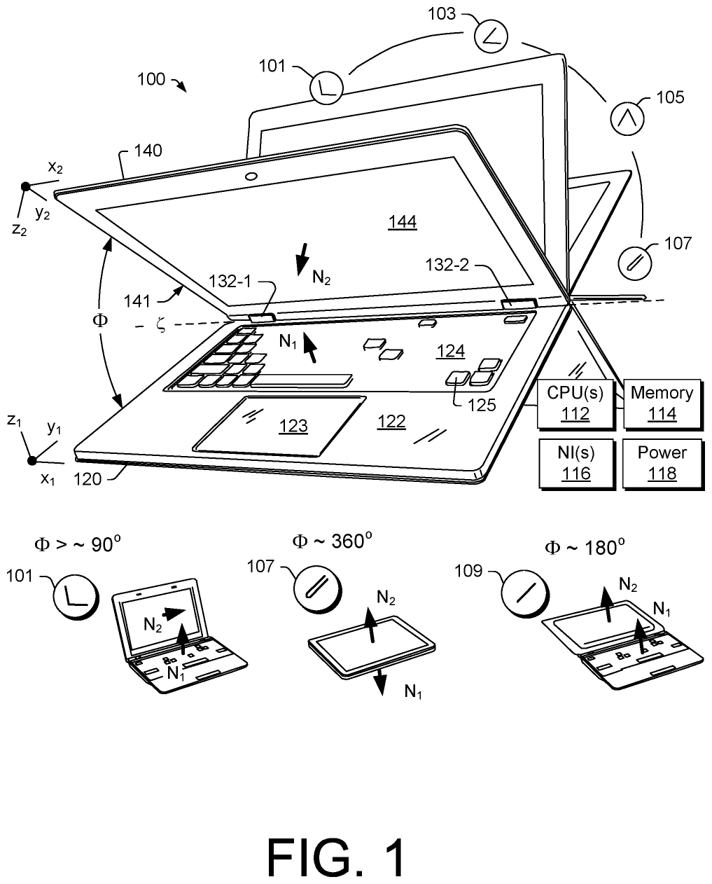

FIG. 1 shows an example of a device 100 that includes a keyboard housing 120 and a display housing 140 that are pivotable with respect to each other via movement about one or more hinges 132-1 and 132-2 (e.g., hinge assemblies). The device 100 may be a system such as, for example, a computing system (e.g., an information handling device, etc.).

As an example, the device 100 may include one or more processors 112, memory 114 (e.g., one or more memory devices), one or more network interfaces 116, and one or more power cells 118. Such components may be, for example, housed within the keyboard housing 120, the display housing 140, or the keyboard housing 120 and the display housing 140.

As shown in the example of FIG. 1, the keyboard housing 120 includes a keyboard 124 with keys 125 and the display housing 140 includes a display 141 with a display surface 144. In such an example, the keyboard 124 is defined in a first Cartesian coordinate system as having a width along an x-axis (x₁), a depth along a y-axis (y₁) and a height or thickness along a z-axis (z₁) that extends in a direction outwardly away from touch surfaces of keys 125 of the keyboard 124 and the display 141 is defined in a second Cartesian coordinate system as having a width along an x-axis (x₂), a depth along a y-axis (y₂) and a height or thickness along a z-axis (z₂) that extends in a direction outwardly away from the viewing surface 144 of the display 141. As an example, a coordinate system may be right-handed or left-handed. In various examples, a footprint may be defined by an area such as an area in an x,y-plane.

As shown in the example of FIG. 1, the one or more hinges 132-1 and 132-2 pivotably connect the keyboard housing 120 and the display housing 140 for orienting the display housing 140 with respect to the keyboard housing 120. For example, orientations may include orientations definable with respect to an axis (e.g., or axes) such as the axis ζ and an angle Φ about that axis.

FIG. 1 shows some examples of orientations 101, 103, 105, 107 and 109. The orientations 101, 103, 105, 107 and 109 may correspond to orientations of a clamshell computing system. The orientation 101 may be a notebook orientation where the angle Φ is about 90 degrees or more (e.g., or optionally somewhat less than about 90 degrees depending on position of a user, etc.). As shown, for the orientation 101, a user may use a finger or fingers of one or both hands to depress keys 125 of the keyboard 124 (e.g., touch typing), for example, while viewing information being rendered to the display 141 of the display housing 140 (e.g., using the one or more processors 112, the memory 114, etc. that may be included in the keyboard housing 120, the display housing 140 or both).

As an example, the keyboard housing 120 may include a frontal surface 122 and may include a touch input surface 123 (e.g., of a touch input device such as a touchpad). As an example, the keyboard 124 may include one or more other input devices (e.g., a control stick, etc.). As an example, the frontal surface 122 may be a surface suitable for resting a palm or palms of a hand or hands. For example, as shown in FIG. 1, the touch input surface 123 can be defined by x and y dimensions where a left palm rest surface is to the left of the touch input surface 123 and where a right palm rest surface is to the right of the touch input surface 123. In such an example, the left and right palm rest surfaces may be defined by respective x and y dimensions as well as a spacing therebetween. Where a device does not include a touch input surface such as the touch input surface 123, the frontal surface 122 may extend in the y direction approximately from a left side of the keyboard housing 120 to a right side of the keyboard housing. Such a surface can be a left and right palm rest surface.

A palm rest surface can allow a user to rest a palm or palms while the user may type (e.g., touch type) using keys of a keyboard that is part of a keyboard housing. For example, a user can rest a palm on a palm rest surface while using one or more finger tips (e.g., or finger pads) to touch keys to thereby instruct a computing system to receive input instructions. In such an example, the keys of the keyboard may be depressible keys. A depressible key may include a spring mechanism that allows the key to be, responsive to finger applied force, depressed a distance in the z direction of the Cartesian coordinate system of a keyboard housing to a level that may be a maximum depression level where, upon release of the force, the key may then return to an undepressed level.

As to the orientation 103, it may correspond to a display orientation for viewing the display 141 where the keyboard 124 faces downward and the device 100 is supported by the keyboard housing 120 (e.g., by a rim about the keyboard 124, the frontal surface 122, etc.). As to the orientation 105, it may correspond to a “tent” orientation where the display 141 faces outwardly for viewing on one side of the tent and the keyboard 124 of the keyboard housing 120 faces outwardly on the other side of the tent.

The orientation 107 may be a tablet orientation where the angle Φ is about 360 degrees such that a normal outward vector N₁ of the keyboard 124 of the keyboard housing 120 (e.g., normal to an x₁,y₁-plane) and a normal outward vector N₂ of the display 141 of the display housing 140 (e.g., normal to an x₂,y₂-plane) are oriented in oppositely pointing directions, pointing away from each other; whereas, in contrast, for a closed orientation of the device 100 (e.g., where the angle Φ is about 0 degrees), the vectors N₁ and N₂ would be pointing toward each other.

In the orientation 107, the keyboard 124 has its keys 125 pointing outwardly in the direction of the vector N₁. Where the keys 125 are depressible keys, when a user grasps the device 100, the keys 125 may be contacted by the users hand or hands. A user may perceive the springiness of the keys 125 as being somewhat undesirable. For example, springy keys may interfere with a user's ability to comprehend or sense force that is sufficient to grasp the device 100, which may cause the user to grasp too lightly or to grasp too strongly, which may possibly impact integrity of the keys (e.g., springs, spring-mechanisms, contacts, etc.). Further, if the user repositions her hand or hands, the user may experience the springiness again. In contrast, a surface without such depressible keys may have a more even feel to a user and may be less distracting. An arrangement that allows for such a surface may include a single hinge that allows for pivoting a keyboard housing with respect to a display housing such that keys of the keyboard housing can be oriented to face a back side of a display housing (a side opposite the display). In such an approach, a user may spin the keyboard housing by 180 degrees about a central axis of the single hinge (e.g., an axis orthogonal to the axis and then rotate the keyboard housing such that the keys face the back side of the display in a folded orientation. In such an example, a single centrally located hinge provides symmetry such that a computing system can be aligned in a clamshell closed orientation and a tablet orientation, optionally with the keys of the keyboard housing facing the back side of a display of a display housing.

The orientation 109 may be a planar orientation where the angle Φ is about 180 degrees such that a normal outward vector N₁ of the keyboard 124 of the keyboard housing 120 and a normal outward vector N₂ of the display 141 of the display housing 140 are oriented in approximately the same pointing directions.

Various computing systems such as laptop or notebook computing devices can be characterized at least in part by a footprint. For example, the device 100 of FIG. 1 may be characterized at least in part by dimensions in x and y as to the keyboard housing 120 and/or as to the display housing 140. As an example, a footprint can be an area that can be defined by a plane in the x and y directions of the Cartesian coordinate systems shown in FIG. 1.

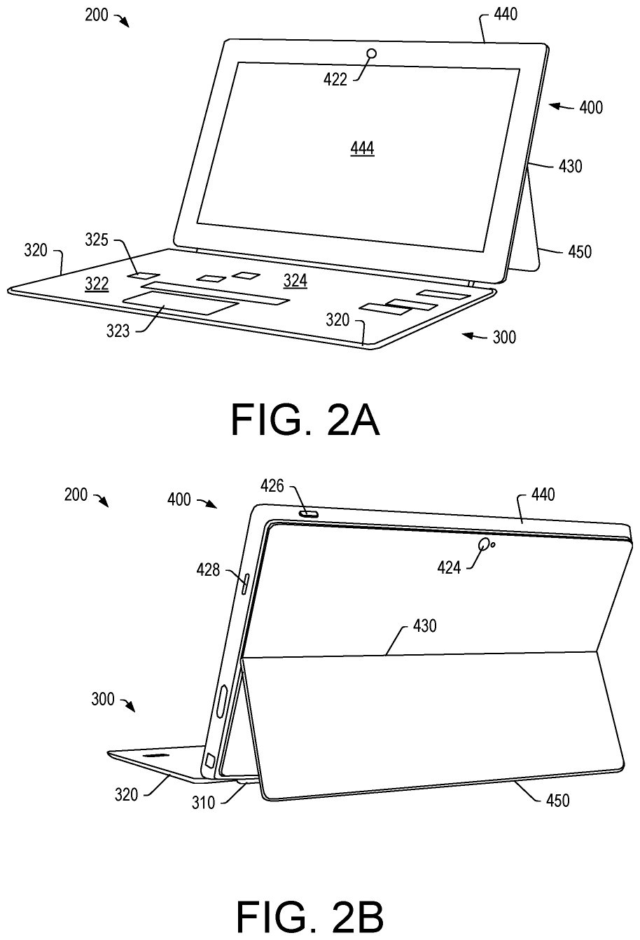

FIG. 2A and FIG. 2B show perspective views of an example of a system 200 that can include one or more features of the device 100 of FIG. 1. For example, the system 200 can include an input device 300 and a display device 400 where the system 200 can include one or more processors, memory (e.g., one or more memory devices), one or more network interfaces, and one or more power cells. Such components may be, for example, housed within the input device 300, the display device 400, or the input device 300 and the display device 400. As an example, the display device 400 can be a tablet form factor computing device, which may be referred to as a display device or a tablet device.

In the example of FIG. 2A and FIG. 2B, the input device 300 can be physically and communicatively coupled to the display device 400 via a flexible hinge 310 of the input device 300. As an example, the input device 300 can include an input device housing 320, a palm rest 322, an input portion that includes a keyboard 324 such as, for example, a QWERTY keyboard (e.g., a QWERTY arrangement of keys 325) and, for example, a touchpad 323. As shown, the display device 400 can include a display device housing 440 with a display 444 and a back side flap 450 that is rotatable a number of degrees via a hinge 430 that couples the back side flap 450 to the display device housing 440. As shown, the display device 400 can include one or more cameras 422 and 424 (e.g., display side and back side), one or more buttons 426 (e.g., edge buttons) and one or more ports 428 (e.g., edge ports).

The flexible hinge 310 is flexible in that rotational movement supported by the hinge is achieved through flexing (e.g., bending) of the material forming the hinge as opposed to mechanical rotation as supported by a pin. The flexible hinge 310 may be formed using one or more layers of fabric and include conductors formed as flexible traces to communicatively couple the input device 300 to the display device 400 and vice versa. Communication may be used to communicate a result of a key press of the input device 300 to the display device 400 and receive power from the display device 400.

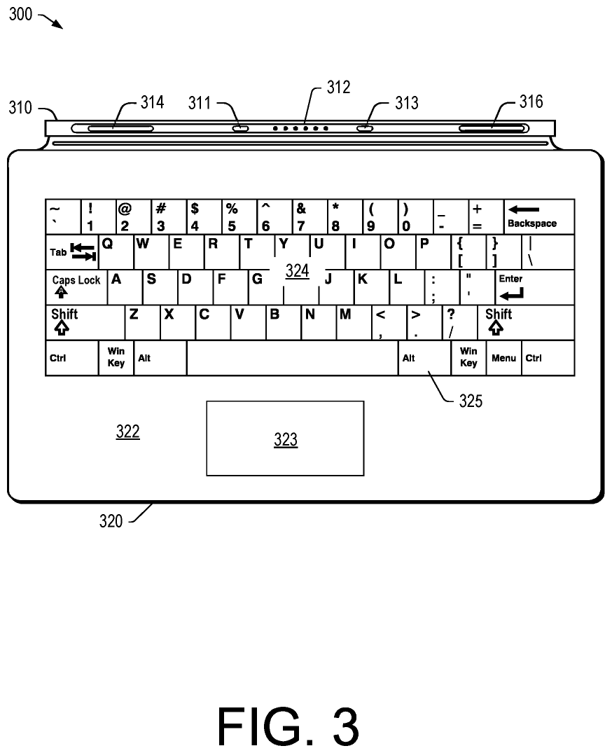

FIG. 3 shows a plan view of the input device 300 showing the flexible hinge 310 in greater detail. As shown, the flexible hinge 310 has a height and cross section configured to be received in a channel in the display device housing 440 of the display device 400. The flexible hinge 310 supports movement of the input device 300 in relation to the display device 400. The flexible hinge 310 includes two linear magnet elements 314 and 316 and two mechanical coupling protrusions 311 and 313 and communication contacts 312. The two linear magnet elements 314 and 316 are configured to magnetically couple to two corresponding linear magnets in a single linear, recessed channel at a bottom edge of the display device housing 440 of the display device 400. The two mechanical coupling protrusions 311 and 313 are also received in the single linear, recessed channel at the bottom edge of the display device housing 440 where the communication contacts 312 contact corresponding communications contacts in the single linear, recessed channel at the bottom edge of the display device housing 440.

Through movement of the flexible hinge 310, the input device 300 may be placed against the display device 400 to thereby act as a cover for the display 444. As shown in FIG. 2A and FIG. 2B, the input device 300 can be utilized in a typing arrangement where the flap 450 is rotated a number of degrees to act as a kickstand that directly supports the display device 400 on a support surface (e.g., a desktop, a tabletop, a countertop, etc.).

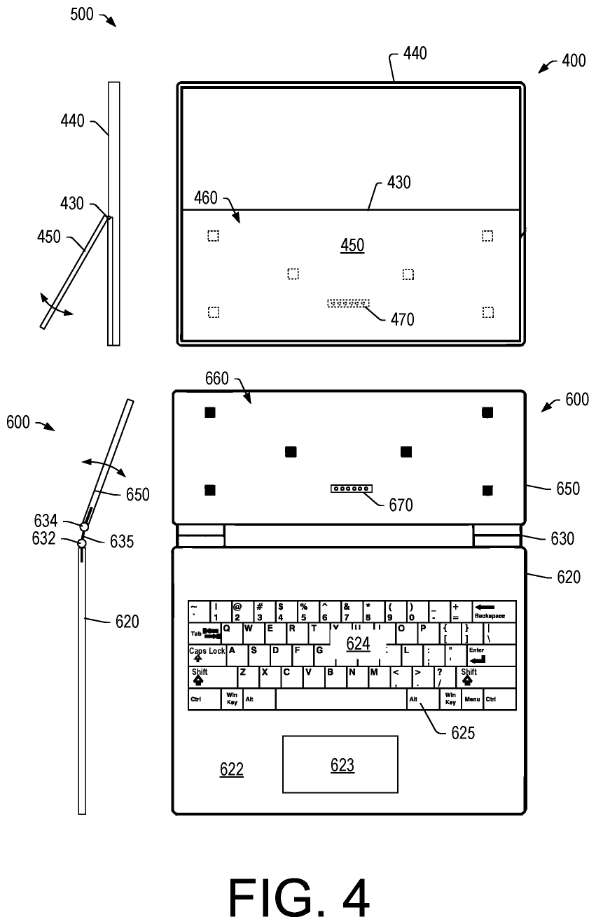

FIG. 4 shows an example of a system 500 that includes an example of the display device 400 and an example of an input device 600 where the input device 600 includes a mechanical hinge 630 that couples an input device housing 620 to a support flap 650 where the flap 450 of the display device 400 includes an arrangement of magnetic material 460 and where the support flap 650 includes an arrangement of magnetic material 660 such that a magnetic attraction force can magnetically couple the flap 450 to the support flap 650.

In the example of FIG. 4, the mechanical hinge 630 can be a multi-axis hinge that may include two or more axis, which may be defined by two or more axles 632 and 634 where a hinge member 635 can bridge the axles 632 and 634. As an example, the mechanical hinge 630 may be a synchronized hinge with meshing gears or may be a friction hinge without gears. Where gears are included, the hinge member 635 may be utilized to assure that the gears mesh; whereas, for a dual axle friction hinge without gears, the hinge member 635 may be a bridge component, which may be fixed relative to two axes or which may be rotatable with respect to the two axes.

As shown in the example of FIG. 4, the input device 600 can include a palm rest 622 (e.g., an upper surface), a touch pad 623 and a keyboard 624 with keys 625, which can be depressible keys. As an example, the input device 600 may include a display, a larger touch pad, a digitizer, etc. As an example, the input device 600 may include a surface that can receive input via a stylus, which may be a passive or an active stylus. For example, consider a digitizer where input can be received via a stylus that can interact with the digitizer to digital register positions, stylus tip pressure, etc.

In the example of FIG. 4, the display device 400 and the input device 600 may be operatively coupled using electrical contacts and/or using wireless circuitry. For example, the system 500 can utilize wireless circuitry such as BLUETOOTH wireless circuitry to couple the display device 400 and the input device 600. As an example, the input device 600 can include one or more batteries such that the input device 600 can power its circuitry.

As an example, the flap 450 can include electrical contacts 470 and the support flap 650 can include electrical contacts 670. In such an example, the electrical contacts 470 and 670 can mate via magnetic attraction force where the arrangements of magnetic materials 460 and 660 provide for proper alignment and contact force. As an example, spring-biased electrical contacts may be utilized (e.g., pogo-pins, etc.).

As an example, the mechanical hinge 630 of the input device 600 can be rotatable with respect to the input device housing 620 over a range of angles from approximately 0 degrees to approximately 360 degrees such that the support flap 650 can likewise be rotatable in a range from approximately 0 degrees to approximately 360 degrees with respect to the input device housing 620.

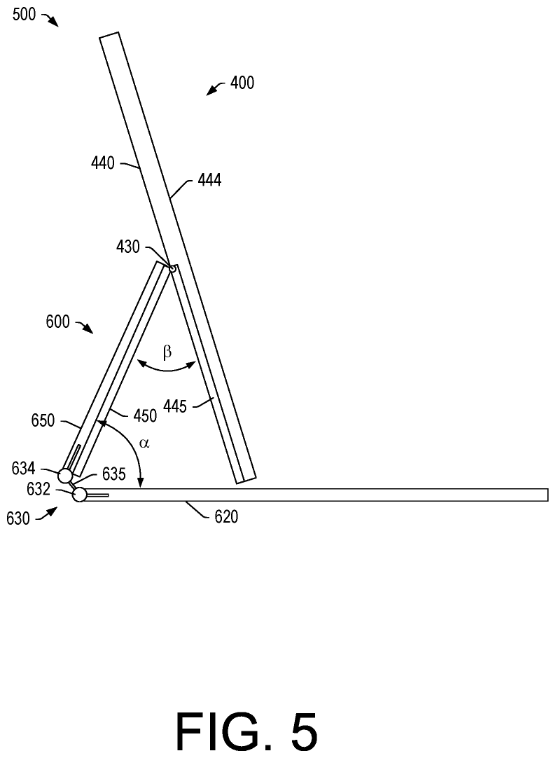

FIG. 5 shows a side view of an example of the system 500 where the input device 600 is coupled to the display device 400 via the flap 450 and the support flap 650. As shown, the mechanical hinge 630 can position the support flap 650 is at an angle α, which is shown to be approximately 68 degrees with respect to the input device housing 620 in the example of FIG. 5, while the flap 450 can be rotated out of a recess 445 of the display device housing 440 by an angle β, which is shown to be approximately 40 degrees in the example of FIG. 5. In such an approach, the display device housing 440 may be rotated via the hinge 430, which can be a mechanical hinge (e.g., consider a piano type of hinge, etc.) to orient the display 444 of the display device 400. For example, the angle β can be adjustable to suit a user's desired viewing angle of the display 444.

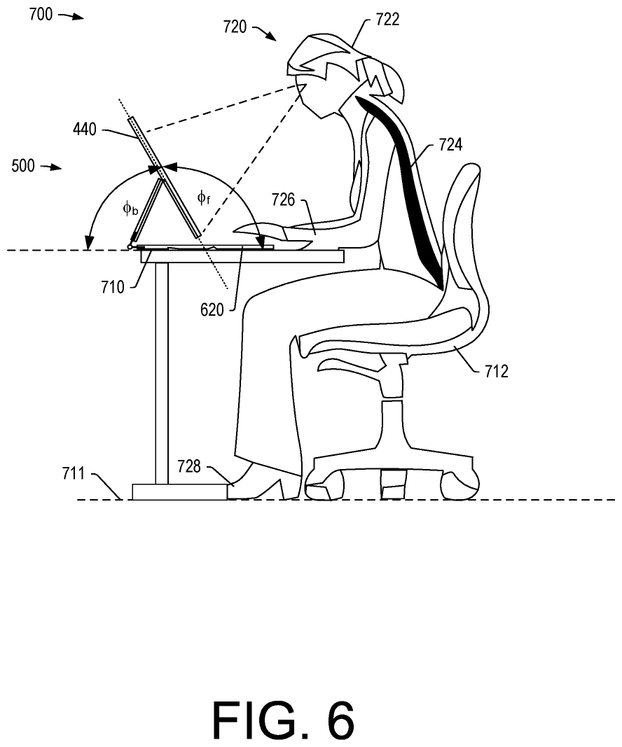

FIG. 6 shows an example scenario 700 where an example of the system 500 is positioned on a desk 710 supported on a floor 711 where a user 720 is seated in a chair 712 supported on the floor 711. As shown, the user 720 can tilt her head 722 with respect to her back 724 to view the display device housing 440 while positioning her hands 726 with respect to the input device housing 620 to perform one or more tasks. As shown, the display device housing 440 may be positioned at an angle ϕ_{f} as measured from a display side or ϕ_{b} as measured from a back side. In the example of FIG. 6, the user 720 may tilt the display housing 440 of the display device 400 via the hinge 430 and/or the user may adjust the support flap 650 of the input device 600 via the hinge 630. Such adjustments can allow for a range of ergonomic positions of the display housing 400, which may be suitable for various scenarios for various users.

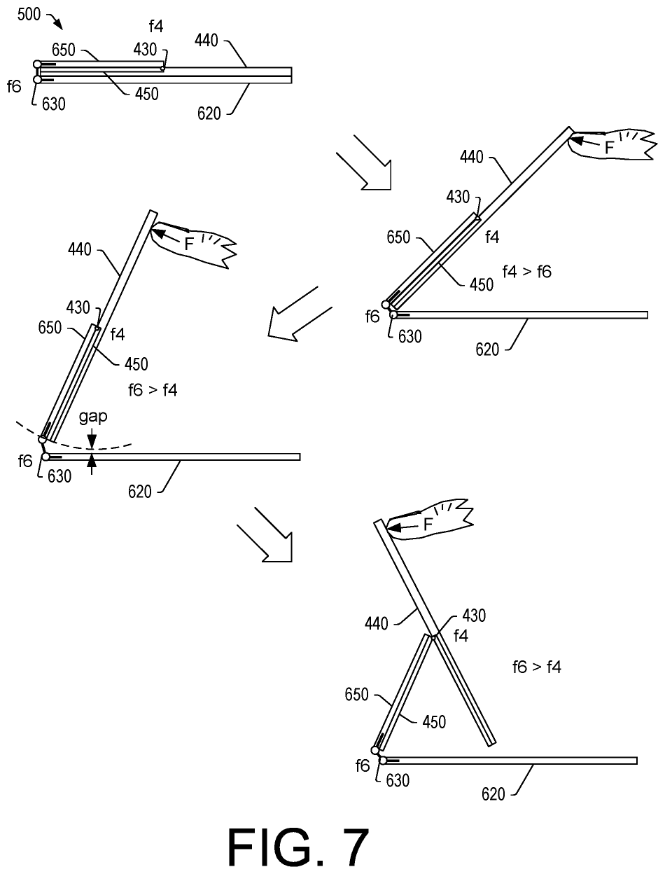

FIG. 7 shows example transitions of an example of the system 500 where friction of the hinge 430 is labeled as f4 and where friction of the hinge 630 is labeled as f6. As an example, the frictions f4 and f6 can differ for various angles. For example, the friction f4 may exceed the friction f6 over a range of angles of the hinge 630 such that the display device housing 440 does not rotate via the hinge 430 during an opening transition. In such an example, the display device housing 440 and the support flap 650 may rotate as a unit about the hinge 630 until the support flap 650 reaches a suitable opening angle, which may be at least 40 degrees and less than 90 degrees. Upon reaching the suitable opening angle, the friction f6 of the hinge 630 can increase such that force applied to the display device housing 440 causes it to rotate about the hinge 430 to thereby allow a user to adjust a viewing angle via rotation about the hinge 430 while the hinge 630 remains stationary (e.g., stable or steady).

In FIG. 7, a portion of a finger is shown as applying a constant force F where when a particular opening angle is reached, the friction f6 is greater than the friction f4 such that the force F causes rotation of the display device housing 440 about the hinge 430 to thereby allow for adjustment of a viewing angle of the display 444 while the hinge 630 remains stationary. Such an approach can allow for single handed (e.g., single finger, etc.) transition of the system 500; whereas, if the friction f6 did not increase to be greater than the friction f4, a user may have to resort to use of two hands, one to steady the support flap 650 and another to adjust the viewing angle of the display device housing 440. Similarly, a user may transition the system 500 from open to closed using a single finger as applied to a back side of the display device housing 440 to first rotate the display device housing 440 about the hinge 430 and then the display device housing 440 via the support flap 650 about the hinge 630.

In the example of FIG. 7, the system 500 can provide a gap such that rotation of the display device housing 440 about the hinge 430 is possible without the lower edge of the display device housing 440 contacting an upper surface of the input device housing 600. For example, such a gap may be formed upon rotation of the support flap 650 by a number of degrees about the hinge 630 where a radius may be measured from an axis of the hinge 430 to the lower edge of the display device housing 440. As an example, an angle or clearance angle may be an angle that is greater than approximately 50 degrees or greater than approximately 55 degrees. In the example of FIG. 7, the clearance angle may be approximately 60 degrees (e.g., 60 degrees+/−10 degrees).

As explained, a dual axis hinge may be utilized that can provide for a distance that can accommodate a display device such that a support flap can lay in a horizontal position over a display device when the display device and the input device are in a closed orientation (see, e.g., the view at the top left of FIG. 7). Such a distance can also provide for a reduction in a clearance angle. For example, without such a distance at the hinge 630, the clearance angle may be 90 degrees as an angle less than 90 degrees may not provide for clearance of the lower edge of the display device housing 440 with respect to the upper surface of the input device 600. Thus, as shown in the example of FIG. 7, the hinge 630 can include a dimension that can provide for folding flat and a reduced clearance angle.

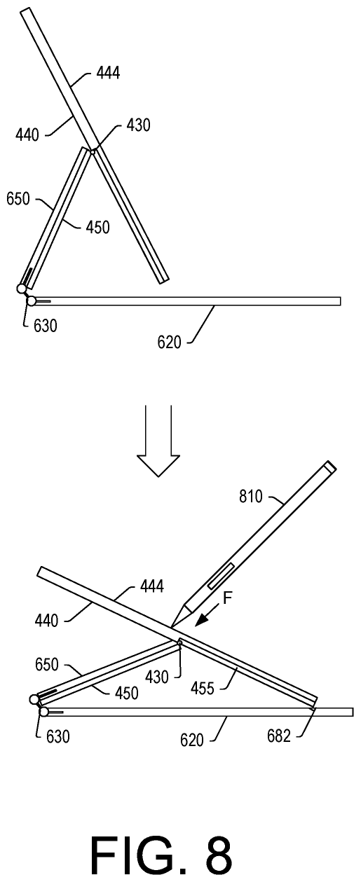

FIG. 8 shows an example of the system 500 as being transitionable from a free standing position of the display device housing 440 of the display device as coupled to the input device 600 to a front edge supported position of the display device housing 440 by the input device 600, which may be suitable for application of force using a finger or a stylus 810. As shown, the support flap 650 of the input device 600 is at an angle less than 45 degrees while the flap 450 of the display device 400 is at an angle that is greater than 90 degrees. In such an example, the input device 600 can include a feature such as a groove 682 or a bump to help support the front edge of the display device housing 440 on a surface of the input device 600. As shown, a triangular shape can be defined by the recess 455, the flap 450 and the support flap 650 where the triangular shape includes various interior angles that can position the display 444 at an angle suitable for application of force.

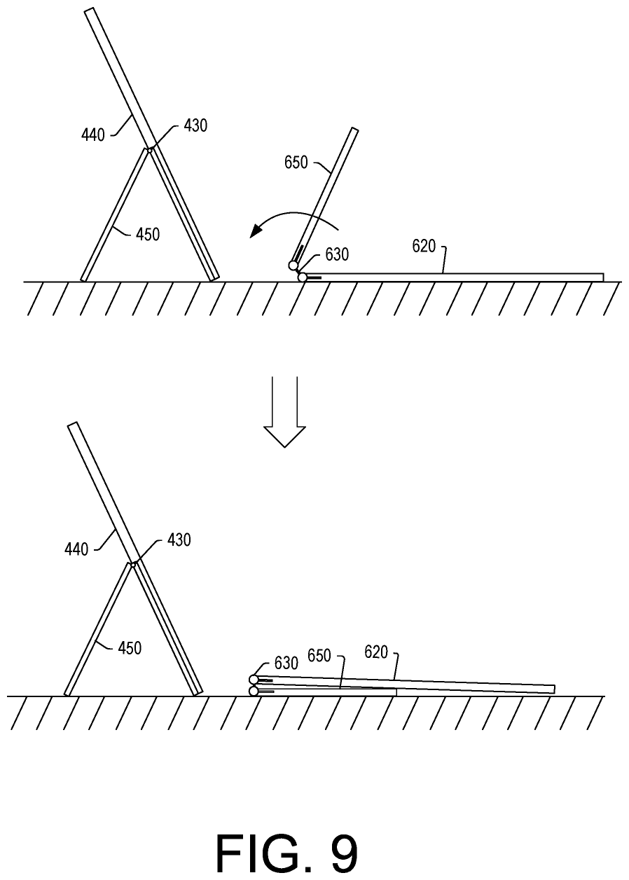

FIG. 9 shows an example of the system 500 where the input device 600 is transitionable from a support position for support of the display device 400 to a tilted position for supporting itself at an angle, which may be an ergonomic angle for using a keyboard of the input device 600. For example, consider an angle that may be in a range from approximately 1 degree to approximately 15 degrees. As shown, the input device 600 may be positioned on a common support surface as the display device 400 with the input device 600 in front of the display device 400 for purposes of input where wired and/or wireless communication may be established such that input received via the input device 600 can control the display device 400. In the example of FIG. 9, the support flap 650 is folded under the input device housing 620 such that the input device housing 620 can be supported at an angle (e.g., from approximately 1 degree to approximately 15 degrees); noting that the support flap 650 may be used to support the input device housing 620 at a greater angle when the support flap 650 is not folded at approximately 360 degrees as in the example of FIG. 9. For example, consider the support flap 650 at an angle of 270 degrees or at another angle, which may be less than or greater than 270 degrees that elevates the back end (hinge end) of the input device housing 620. As explained, the input device 600 may include a touchpad, a digitizer, etc., where the support flap 650 can support the input device housing 620 at a desirable angle for use (e.g., using a finger, fingers, a stylus, etc.).

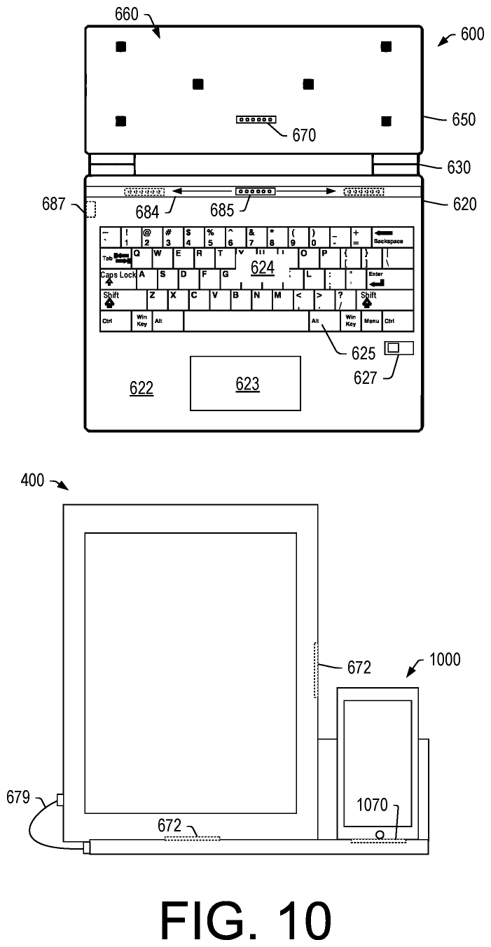

FIG. 10 shows an example of the input device 600 as optionally including one or more features for connectivity, positioning, etc. For example, the input device 600 can include a groove 684 that may include a connector 685, which may be adjustable such as being translatable along the groove 684. As shown, the input device 600 can include one or more ports 687, which may be at an edge for coupling to a power source and/or to a device. As an example, the support flap 650 can be positioned using the hinge 630 to provide a suitable viewing angle for one or more devices where, for example, the groove 684 is utilized to support an edge of a device or edges of devices. As an example, a surface of the input device 600 may be rubberized such that a sufficiently high friction coefficient exists to make the surface anti-slip such that an edge of a device supported by the input device 600 does not slip (e.g., to maintain a desired viewing angle of the device).

As shown in the example of FIG. 10, the input device 600 may support the display device 400 in a portrait position. For example, the display device 400 can be rectangular with long edges and short edges where a landscape position the long edges can be horizontal whereas for a portrait position the short edges can be horizontal. As shown, where the display device 400 is in a portrait position with respect to the input device 600, space may exist for supporting another device 1000, which may be a smart phone. In the example of FIG. 10, the display device 400 and/or the device 1000 may include one or more connectors 672 and 1070, respectively, which may be suitable for connecting to one or more connectors of the input device 600. As shown, a cable 679 may be optionally utilized, for example, via the port 687 of the input device 600 to a port of the display device 400. As an example, where multiple devices are supported by the input device 600, the input device 600 may include a switch 627 that can be utilized to selectively couple to one of the multiple devices. As an example, one or more types of connections may be utilized and/or one or more instances of a type of connector to connect an input device to one or more of multiple devices.

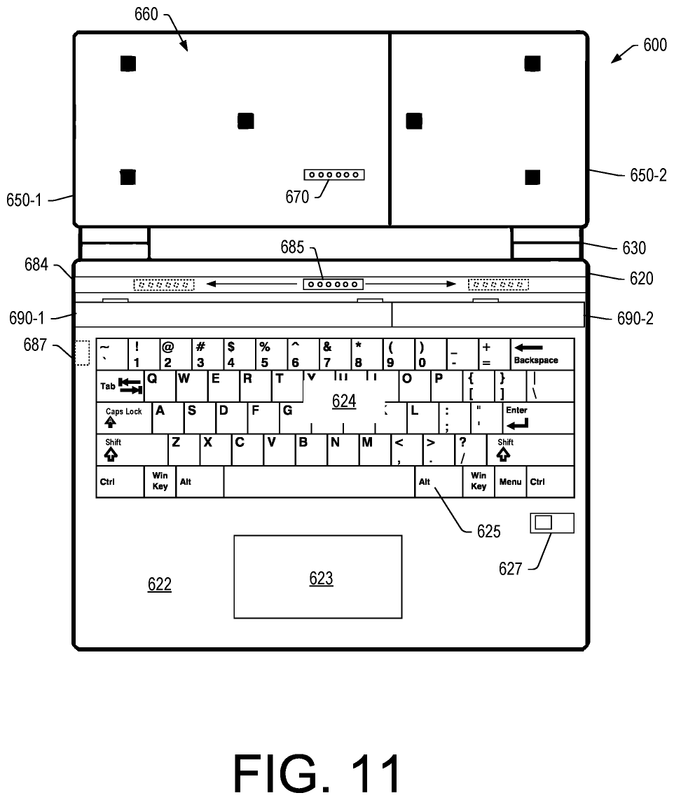

FIG. 11 shows an example of the input device 600 as optionally including a spit support flap such that the support flap includes two portions 650-1 and 650-2 that may be independently adjustable, for example, to adjust angles of two devices (see, e.g., the display device 400 and the device 1000 of FIG. 10). In the example of FIG. 11, the input device 600 is shown as optionally including one or more other flaps 690-1 and 690-2 that may be disposed between an edge of the keyboard 624 and the hinge 630. Such a flap or flaps may optionally be included with or without the groove 684. Such a flap can be hinged such that the flap can lay flat (e.g., flush) with the keyboard 624 and may be deployed where desired. As an example, a device may be supported by the input device 600 by the flap 650 or a portion thereof and another flap such as one of the flap portions 690-1 and 690-2; noting that a continuous single flap may be included.

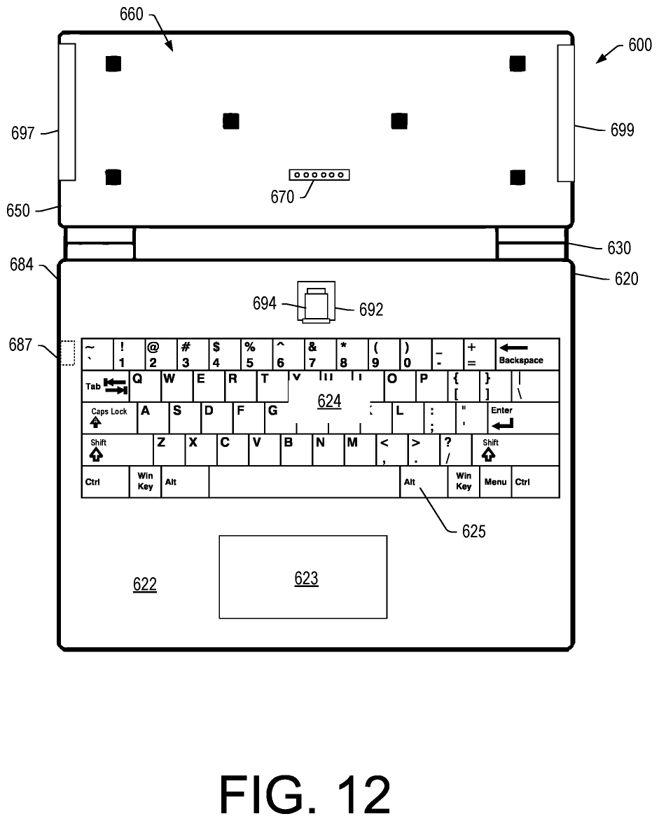

FIG. 12 shows an example of the input device 600 as optionally including a connector 694 that may be set in a recess 692 where the connector 694 can be a pop-up connector that is optionally positionable (e.g., translatable, etc.). In such an example, a display device may be connected electronically via the connector 694. While a single connector is shown in the example of FIG. 12, the input device 600 may include one or more connectors, optionally of different types. As an example, the connector 694 may be a USB type of connector (e.g., USB-C type). As an example, the connector 694 may include an extendible cable that may pull out of and recoil into the input device housing 620.

FIG. 12 also shows the support flap 650 as optionally including clips 697 and 699, which may be utilized with a display device that may not include magnets or may not include magnets that can be properly aligned with the arrangement of magnetic material 660 of the support flap 650. For example, the clips 697 and 699 may form slots (e.g., U shaped slots, etc.) where a display device can be translated into and out of the clips 697 and 699.

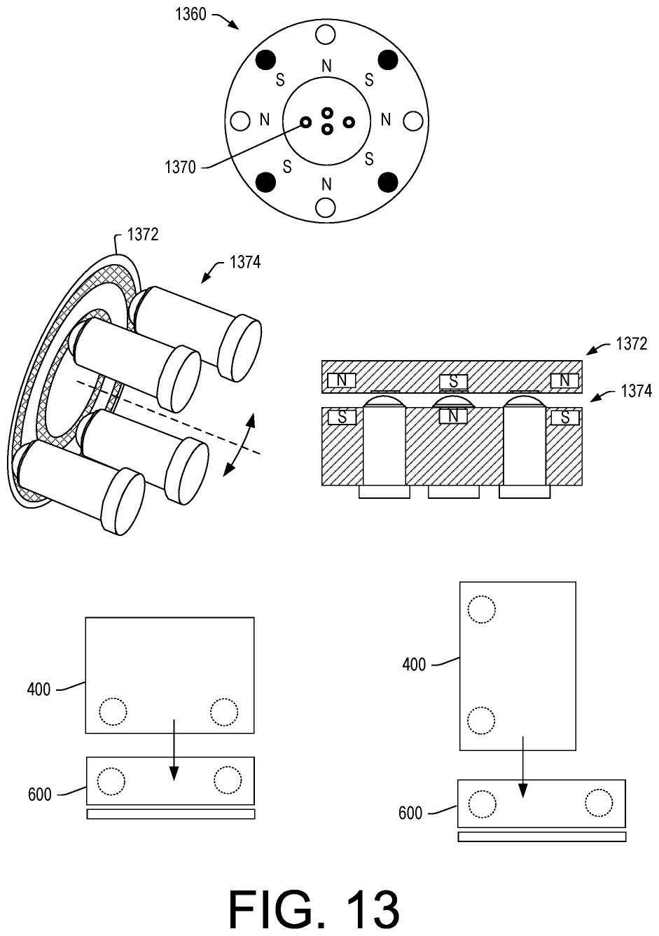

FIG. 13 shows examples of arrangements of magnetic materials 1360 and examples of connectors 1370. As an example, a pattern of magnetic material can be in an array, which may be rectangular, circular, etc. In the example arrangement 1360 of FIG. 13, various magnetic poles are labeled where a mating arrangement may include opposing magnetic poles.

As an example, a display device and/or a flap of a display device can include a circular pattern that may provide for positioning of the display device in a landscape position and optionally in a portrait position. As an example, a circular pattern of electrical contacts 1372 and 1374 may be utilized, which may include use of one or more magnets. As shown, the electrical contacts 1374 can include spring-biased contacts (e.g., balls spring loaded in cylinders, pogo-pins, etc.).

As an example, various patterns may be utilized for different positions of a display device with respect to an input device. As shown, the display device 600 can include one or more arrangements of magnetic materials and/or connectors, which may be part of a flap or part of a display device housing. In FIG. 13, a landscape position of the display device 400 is shown that can include using one or more couplings with one or more corresponding couplings of the input device 600. In such an example, the display device 400 can also be positioned in a portrait position where at least one pair of couplings can couple the display device 400 and the input device 600.

As an example, a hinge can include one or more hinge assemblies. For example, consider the hinge 630 as including axles and leafs. As an example, a hinge can include one or more gears such that the hinge is a synchronous hinge. A synchronous hinge can be a dual-axle hinge where the axles rotate synchronously. Such a hinge can provide for a flat, planar orientation (e.g., 180 degree position) and a folded orientation (e.g., a 0 degree position). As an example, such a hinge may provide for another folded orientation (e.g., 360 degree position).

As an example, a hinge may be a single piano type of hinge that extends a distance along an axis. In such an example, leaves of the piano type of hinge can be attached to components with an exposed barrel portion that receives a pin (e.g., an axle, etc.).

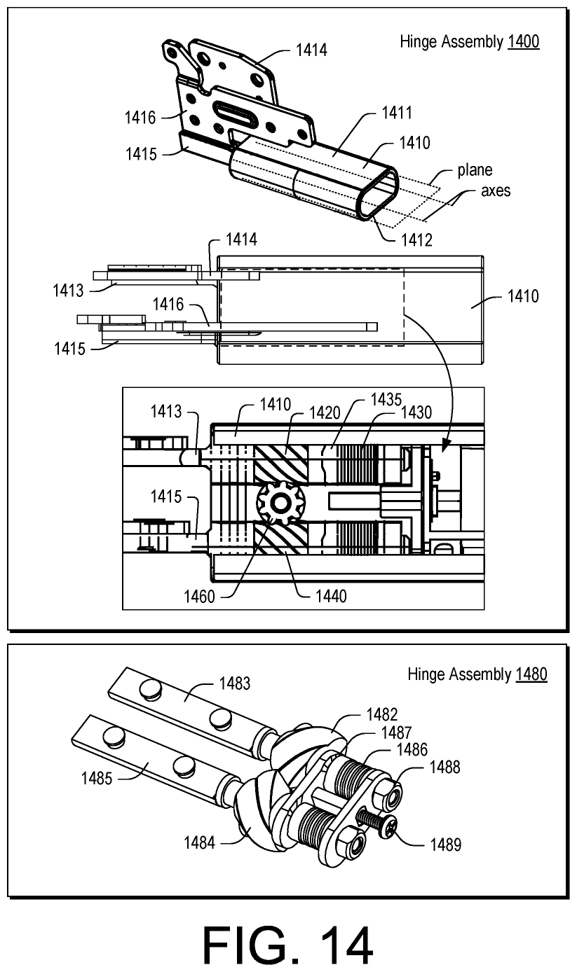

FIG. 14 shows an example of a hinge assembly 1400 and an example of a hinge assembly 1480. As an example, the hinge 630 may include features of the hinge assembly 1400 and/or the hinge assembly 1480.

As shown in FIG. 14, the hinge assembly 1400 includes a housing 1410 with opposing sides 1411 and 1412, axles 1413 and 1415 with corresponding axes, saddles 1414 (coupled to the axle 1413) and 1416 (coupled to the axle 1415), gears 1420, 1440 and 1460 and a tensioning mechanism 1430 (e.g., a stack of coned washers, etc.). In the hinge assembly 1400, the gear 1460 is an intermediate gear that is disposed between the gears 1420 and 1440. As shown, the intermediate gear 1460 has a rotational axis that is orthogonal to the rotational axes of the gears 1420 and 1440. In such an example, the intermediate gear 1460 can allow for spacing of axles 1413 and 1415.

In the example of FIG. 14, the saddles 1414 and 1416 (e.g., leafs) can be operatively coupled to respective portions of a device such that the portions can be oriented from an approximately 0 degree folded orientation to an approximately 180 degrees flat, planar orientation.

In FIG. 14, the hinge assembly 1480 includes gears 1482 and 1484, axles 1483 and 1485, a tension mechanism 1486, nuts 1488 and a tensioning component 1489. As an example, the hinge assembly 1480 may include a housing such as the housing 1410.

As an example, a hinge assembly can include two or more gears. As an example, a hinge assembly can include two or more axles. As an example, a hinge assembly can include two or more gears and two axles that have rotational axes that are substantially parallel to each other where each of the two axles is operatively coupled to a respective portion of a device.

FIG. 14 shows the hinge assembly 1400 as including substantially parallel rotational axes of the two axles 1413 and 1415 that can define a plane (see dashed lines and labels). In the example hinge assembly 1400 of FIG. 14, the housing 1410 includes a tubular shape, which may be described as being a flattened tube where the opposing sides 1411 and 1412 are substantially flat, opposing and parallel sides joined by rounded ends. In such an example, the substantially flat, opposing and parallel sides 1411 and 1412 can be substantially parallel to either side of a plane defined by the axles 1413 and 1415. Where the housing 1410 is in a stationary coordinate system, the saddles 1414 and 1416 may be rotated about the respective axes of the axles 1413 and 1415, for example, from an orientation as shown in FIG. 14 to another orientation where each of the saddles 1414 and 1416 has been rotated approximately 180 degrees, the saddle 1416 being rotated counter-clockwise and the saddle 1414 being rotated clockwise when viewing the housing 1410 from the open end shown in FIG. 14. As an example, a hinge assembly can be a friction hinge assembly that may be without one or more lock points along its rotation. For example, a hinge assembly can have a variable 360 degree rotation with a set specified torque that meets specification as to ergonomics for a user.

As explained, a hinge assembly or hinge assemblies can include variable friction, which may be variable with respect to rotation, for example, as explained with respect to the example of FIG. 7. Variable friction may be achieved using one or more techniques. For example, consider one or more cams, one or more washers (e.g., spring washers, etc.) with an asymmetric shape or shapes, one or more levels of interference between components (e.g., gears, axles, bushings, couplings, plates, etc.). As to a cam approach, one or more rotating surfaces may be shaped unevenly such that an axial force increases or decreases during rotation. For example, a pair of surfaces can include ridges and valleys where rotation that causes ridges to align results in increased axial force that thereby increases frictional force making rotation more difficult (e.g., demands more force); whereas, rotation that causes ridges to be received in valleys, axial force can diminish such that rotation is easier (e.g., demands less force). In the example hinge assembly 1400, components 1435 may include a pair of cam surfaces; whereas, in the hinge assembly 1480, a coupling 1487 may include a shaped surface that can act in a cam-like manner with one or more other surfaces, noting that the gears 1482 and 1484 may include shaped end surfaces that interact with one or more surfaces of the coupling 1487.

As an example, a system can include a display device that includes a display device housing, a display, a display side, a back side, a back side flap and a flap hinge that couples the back side flap to the housing; and an input device that includes an input device housing, a support flap and a support flap hinge that couples the support flap to the input device housing, where the support flap includes a coupling that couples the support flap to the back side flap of the display device. In such an example, the support flap hinge can include a range of motion from approximately 0 degrees to approximately 360 degrees.

As an example, a support flap hinge can include variable friction that depends on an angle of rotation of a support flap with respect to an input device housing. For example, variable friction can be greater at a clearance angle greater than at 10 degrees, where the clearance angle provides a gap between a lower edge of a display device housing and an upper surface of the input device housing for rotation of the display device housing via a flap hinge.

As an example, at a clearance angle, a support flap can provide a gap between a lower edge of a display device housing and an upper surface of an input device housing for rotation of the display device housing via a flap hinge, wherein the clearance angle is less than 80 degrees.

As an example, a support flap hinge can include multiple axles. In such an example, the support flap hinge can include gears and/or multiple axles that are spaced at a distance where, for example, the distance is approximately equal to a thickness of a display device housing.

As an example, a coupling can include an arrangement of magnets. For example, consider an arrangement of magnets that includes radial symmetry.

As an example, a support flap can include electrical contacts. In such an example, a back side flap of a display device can include electrical contacts.

As an example, an input device can include one or more batteries. In such an example, the input device can include wireless communication circuitry.

As an example, a flap hinge can include a range of motion from approximately 0 degrees to at least 60 degrees.

As an example, a display device housing can include a rectangular perimeter with long edges and short edges. In such an example, the display device can be supportable by an input device in a portrait position and in a landscape position.

As an example, a back side flap of a display device can include independently rotatable portions.

As an example, an input device housing can include a groove and an electrical connector disposed in the groove. In such an example, a display device may include an electrical connector that can mate with the electrical connector disposed in the groove.

The term “circuit” or “circuitry” is used in the summary, description, and/or claims. As is well known in the art, the term “circuitry” includes all levels of available integration (e.g., from discrete logic circuits to the highest level of circuit integration such as VLSI, and includes programmable logic components programmed to perform the functions of an embodiment as well as general-purpose or special-purpose processors programmed with instructions to perform those functions) that includes at least one physical component such as at least one piece of hardware. A processor can be circuitry. Memory can be circuitry. Circuitry may be processor-based, processor accessible, operatively coupled to a processor, etc. Circuitry may optionally rely on one or more computer-readable media that includes computer-executable instructions. As described herein, a computer-readable medium may be a storage device (e.g., a memory chip, a memory card, a storage disk, etc.) and referred to as a computer-readable storage medium, which is non-transitory and not a signal or a carrier wave.

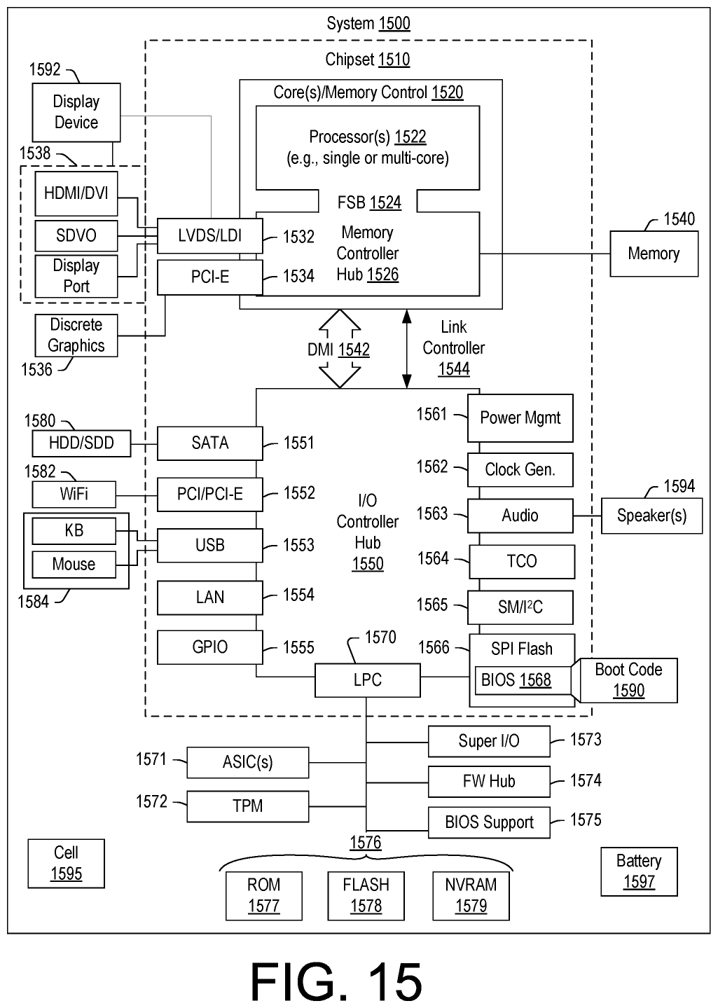

While various examples of circuits or circuitry have been discussed, FIG. 15 depicts a block diagram of an illustrative computer system 1500. The system 1500 may be a computer system, such as one of the LENOVO® THINKCENTRE® or LENOVO® THINKPAD® series of personal computers sold by Lenovo (US) Inc. of Morrisville, NC, or a workstation computer system, such as the LENOVO® THINKSTATION®, which are sold by Lenovo (US) Inc. of Morrisville, NC; however, as apparent from the description herein, a system or other machine may include other features or only some of the features of the system 1500. As an example, a display device may include features of the system 1500. As an example, a display device, which may be a computer system, may include one or more of the features of the LENOVO® IDEACENTRE® or THINKCENTRE® “all-in-one” (AIO) computing devices, which are sold by Lenovo (US) Inc. of Morrisville, NC. For example, the LENOVO® IDEACENTRE® A720 computing device includes an Intel® Core i7 processor, a 27 inch frameless multi-touch display (e.g., for HD resolution of 1920×1080), a NVIDIA® GeForce® GT 630M 2 GB graphics card, 8 GB DDR3 memory, a hard drive, a DVD reader/writer, integrated Bluetooth® and 802.11b/g/n Wi-Fi®, USB connectors, a 6-in-1 card reader, a webcam, HDMI in/out, speakers, and a TV tuner.

As shown in FIG. 15, the system 1500 includes a so-called chipset 1510. A chipset refers to a group of integrated circuits, or chips, that are designed (e.g., configured) to work together. Chipsets are usually marketed as a single product (e.g., consider chipsets marketed under the brands INTEL®, AMD®, etc.).

In the example of FIG. 15, the chipset 1510 has a particular architecture, which may vary to some extent depending on brand or manufacturer. The architecture of the chipset 1510 includes a core and memory control group 1520 and an I/O controller hub 1550 that exchange information (e.g., data, signals, commands, etc.) via, for example, a direct management interface or direct media interface (DMI) 1542 or a link controller 1544. In the example of FIG. 15, the DMI 1542 is a chip-to-chip interface (sometimes referred to as being a link between a “northbridge” and a “southbridge”).

The core and memory control group 1520 include one or more processors 1522 (e.g., single core or multi-core) and a memory controller hub 1526 that exchange information via a front side bus (FSB) 1524. As described herein, various components of the core and memory control group 1520 may be integrated onto a single processor die, for example, to make a chip that supplants the conventional “northbridge” style architecture.

The memory controller hub 1526 interfaces with memory 1540. For example, the memory controller hub 1526 may provide support for DDR SDRAM memory (e.g., DDR, DDR2, DDR3, etc.). In general, the memory 1540 is a type of random-access memory (RAM). It is often referred to as “system memory”.

The memory controller hub 1526 further includes a low-voltage differential signaling interface (LVDS) 1532. The LVDS 1532 may be a so-called LVDS Display Interface (LDI) for support of a display device 1592 (e.g., a CRT, a flat panel, a projector, etc.). A block 1538 includes some examples of technologies that may be supported via the LVDS interface 1532 (e.g., serial digital video, HDMI/DVI, display port). The memory controller hub 1526 also includes one or more PCI-express interfaces (PCI-E) 1534, for example, for support of discrete graphics 1536. Discrete graphics using a PCI-E interface has become an alternative approach to an accelerated graphics port (AGP). For example, the memory controller hub 1526 may include a 16-lane (×16) PCI-E port for an external PCI-E-based graphics card. A system may include AGP or PCI-E for support of graphics. As described herein, a display may be a sensor display (e.g., configured for receipt of input using a stylus, a finger, etc.). As described herein, a sensor display may rely on resistive sensing, optical sensing, or other type of sensing.

The I/O hub controller 1550 includes a variety of interfaces. The example of FIG. 15 includes a SATA interface 1551, one or more PCI-E interfaces 1552 (optionally one or more legacy PCI interfaces), one or more USB interfaces 1553, a LAN interface 1554 (more generally a network interface), a general purpose I/O interface (GPIO) 1555, a low-pin count (LPC) interface 1570, a power management interface 1561, a clock generator interface 1562, an audio interface 1563 (e.g., for speakers 1594), a total cost of operation (TCO) interface 1564, a system management bus interface (e.g., a multi-master serial computer bus interface) 1565, and a serial peripheral flash memory/controller interface (SPI Flash) 1566, which, in the example of FIG. 15, includes BIOS 1568 and boot code 1590. With respect to network connections, the I/O hub controller 1550 may include integrated gigabit Ethernet controller lines multiplexed with a PCI-E interface port. Other network features may operate independent of a PCI-E interface.

The interfaces of the I/O hub controller 1550 provide for communication with various devices, networks, etc. For example, the SATA interface 1551 provides for reading, writing or reading and writing information on one or more drives 1580 such as HDDs, SDDs or a combination thereof. The I/O hub controller 1550 may also include an advanced host controller interface (AHCI) to support one or more drives 1580. The PCI-E interface 1552 allows for wireless connections 1582 to devices, networks, etc. The USB interface 1553 provides for input devices 1584 such as keyboards (KB), one or more optical sensors, mice and various other devices (e.g., microphones, cameras, phones, storage, media players, etc.). On or more other types of sensors may optionally rely on the USB interface 1553 or another interface (e.g., I²C, etc.). As to microphones, the system 1500 of FIG. 15 may include hardware (e.g., audio card) appropriately configured for receipt of sound (e.g., user voice, ambient sound, etc.).

In the example of FIG. 15, the LPC interface 1570 provides for use of one or more ASICs 1571, a trusted platform module (TPM) 1572, a super I/O 1573, a firmware hub 1574, BIOS support 1575 as well as various types of memory 1576 such as ROM 1577, Flash 1578, and non-volatile RAM (NVRAM) 1579. With respect to the TPM 1572, this module may be in the form of a chip that can be used to authenticate software and hardware devices. For example, a TPM may be capable of performing platform authentication and may be used to verify that a system seeking access is the expected system.

The system 1500, upon power on, may be configured to execute boot code 1590 for the BIOS 1568, as stored within the SPI Flash 1566, and thereafter processes data under the control of one or more operating systems and application software (e.g., stored in system memory 1540). An operating system may be stored in any of a variety of locations and accessed, for example, according to instructions of the BIOS 1568. Again, as described herein, a satellite, a base, a server or other machine may include fewer or more features than shown in the system 1500 of FIG. 15. Further, the system 1500 of FIG. 15 is shown as optionally include cell phone circuitry 1595, which may include GSM, CDMA, etc., types of circuitry configured for coordinated operation with one or more of the other features of the system 1500. Also shown in FIG. 15 is battery circuitry 1597, which may provide one or more battery, power, etc., associated features (e.g., optionally to instruct one or more other components of the system 1500). As an example, a SMBus may be operable via a LPC (see, e.g., the LPC interface 1570), via an I²C interface (see, e.g., the SM/I²C interface 1565), etc.

Although examples of methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

What is claimed is:

1. A system comprising:
a display device that comprises a display device housing, a display, a display side, a back side, a back side flap and a flap hinge that couples the back side flap to the housing; and
an input device that comprises an input device housing, a support flap and a support flap hinge that couples the support flap to the input device housing, wherein the support flap comprises a coupling that couples the support flap to the back side flap of the display device.

2. The system of claim 1, wherein the support flap hinge comprises a range of motion from approximately 0 degrees to approximately 360 degrees.

3. The system of claim 1, wherein the support flap hinge comprises variable friction that depends on an angle of rotation of the support flap with respect to the input device housing.

4. The system of claim 3, wherein the variable friction is greater at a clearance angle greater than at 10 degrees, wherein the clearance angle provides a gap between a lower edge of the display device housing and an upper surface of the input device housing for rotation of the display device housing via the flap hinge.

5. The system of claim 1, wherein, at a clearance angle, the support flap provides a gap between a lower edge of the display device housing and an upper surface of the input device housing for rotation of the display device housing via the flap hinge, wherein the clearance angle is less than 80 degrees.

6. The system of claim 1, wherein the support flap hinge comprises multiple axles.

7. The system of claim 6, wherein the support flap hinge comprises gears.

8. The system of claim 6, wherein multiple axles are spaced at a distance.

9. The system of claim 8, wherein the distance is approximately equal to a thickness of the display device housing.

10. The system of claim 1, wherein the coupling comprises an arrangement of magnets.

11. The system of claim 10, wherein the arrangement of magnets comprise radial symmetry.

12. The system of claim 1, wherein the support flap comprises electrical contacts.

13. The system of claim 12, wherein the back side flap comprises electrical contacts.

14. The system of claim 1, wherein the input device comprises a battery.

15. The system of claim 14, wherein the input device comprises wireless communication circuitry.

16. The system of claim 1, wherein the flap hinge comprises a range of motion from approximately 0 degrees to at least 60 degrees.

17. The system of claim 1, wherein the display device housing comprises a rectangular perimeter with long edges and short edges.

18. The system of claim 18, wherein the display device is supportable by the input device in a portrait position and in a landscape position.

19. The system of claim 1, wherein the back side flap comprises independently rotatable portions.

20. The system of claim 1, wherein the input device housing comprises a groove and an electrical connector disposed in the groove.
